(19) United States
(12) Patent Application Publication
(10) Pub. No.: US 2023/0180026 A1
(43) Pub. Date: Jun. 8, 2023

(54) NODE CONTROL UNIT AND NETWORK-SERVICE DEVICE

(71) Applicant: SIGNIFY HOLDING B.V., EINDHOVEN (NL)

(72) Inventors: PETER DEIXLER, ARLINGTON, MA (US); BOZENA ERDMANN, AACHEN (DE); LEENDERT TEUNIS ROZENDAAL, VALKENSWAARD (NL)

(21) Appl. No.: 17/923,717

(22) PCT Filed: Apr. 30, 2021
(86) PCT No.: PCT/EP2021/061487

§ 371 Date: Nov. 7, 2022

Related U.S. Application Data
(60) Provisional application No. 63/025,257, filed on May 15, 2020.

(30) Foreign Application Priority Data
May 28, 2020 (EP) 20177200.1

(51) Int. Cl. H04W 24/02; H04W 24/08; H04W 64/00

(52) U.S. Cl. CPC H04W 24/02; H04W 24/08; H04W 64/003

(57) ABSTRACT

The invention relates to a node-control unit (100) for setting an operation mode of one or more network nodes (102) of a wireless communication network (150). It comprises a network-service-detection unit (104), for ascertain that a network-service device (106) is currently available for communicating with the wireless communication network, and to provide a respective service-availability signal (SA) indicative thereof, and an operation-mode setting unit (108) configured to receive the service-availability signal (SA) and, to generate and provide based thereon, a first switch-mode signal (SM1) to at least one network node indicative of an instruction to switch the operation mode from a first operation mode where the network node acts as a node of the wireless communication network to a second operation mode wherein the network node is in communication with the respective external network-service device thereby enabling an ad-hoc adjustment of the functionality of the network node.

### FIELD OF THE INVENTION

The invention is related to a node-control unit, to a network node, to a network-service device, to a wireless communication network, to respective methods for operating a node-control unit, a network node, and a network-service device, and to a computer program.

### BACKGROUND OF THE INVENTION

US 2019/0028886 A1 discloses a configuration system arranged to configure a first set of wireless network devices or nodes to form a first stand-alone wireless communication network. A configuration device is arranged to wirelessly connect with the first set of wireless network nodes and to transfer the first configuration parameters to the first set of wireless network nodes forming the first stand-alone wireless communication network. The first configuration parameters are selected to be compatible with a future connected wireless network if the first set of wireless network devices and a second set of wireless network devices are placed so that they may be connected to a same network-service device forming a future connected wireless network.

### SUMMARY OF THE INVENTION

It would be beneficial to enable an ad-hoc adjustment of the functionality of a network node.

A first aspect of the present invention is formed by a node-control unit for setting an operation mode of one or more network nodes of a wireless communication network. The node-control unit comprises a network-service-detection unit that is configured to ascertain that one or more network-service devices, which are currently external to the wireless communication network, are available for communication with at least one of the network nodes of the wireless communication network and thus become part of the wireless communication network and to provide a respective service-availability signal indicative thereof.

The node-control unit also comprises an operation-mode setting unit that is configured to control switching of an operation mode of at least one of the network nodes between a first operation mode of the at least one network nodes as a network node of the wireless communication network in a first network configuration, which excludes the respective network-service device and in a second operation mode of the at least one network node as a network node of the wireless communication network in a second network configuration, which includes the respective network-service device in the wireless communication network. The operation-mode setting unit is further configured, in response to receiving the respective service-availability signal, to generate and provide to at the least one of the network nodes of the wireless communication network, via an output interface, a corresponding first switch-mode signal indicative of an instruction to switch the operation mode from the first operation mode to the second operation mode with respect to the given network-service device.

The node-control unit is therefore advantageously configured to drive the operation of one or more network nodes in dependence on whether one or more suitable network-service devices are available, and thereby to adapt its functionality in dependency on the available network-service devices.

In the following, embodiments of the node-control unit of the first aspect of the invention will be described.

In an embodiment, different network-service devices that are available for communication with at least one of the network nodes and thus for becoming part of the wireless communication network have different network “membership tiers” wherein network-service devices with a lower membership tier have more limited rights and/or trust within the wireless communication network, e.g., for allowed use of bandwidth, for changing the routing, etc., than network-service devices with higher membership tiers.

In an embodiment, a network-service device is considered to have joined the wireless communication network when a bi-directional interfacing, i.e. a full-fledged network link, with at least one of the network nodes of the wireless communication network is formed.

In a particular embodiment, the output interface of the operation-mode setting unit is a node-internal communication interface between hardware or software modules of the node. In another embodiment, the output interface of the operation-mode setting unit is a transmitting unit for communication over the wireless communication network or another suitable communication interface.

In an embodiment, the first operation mode corresponds to an operation of the at least one network node as a network node of a standalone wireless communication network, i.e. a network without a dedicated network-service device such as a gateway device, access point, bridge, hub, controller, smart speaker, a router, such as a border router, connecting two or more wireless communication networks, which may be of different types. or any other device for communicating with devices outside the wireless communication network or for conveying information from and/or to devices not forming part of the wireless communication network.

In an alternative embodiment, the first operation mode corresponds to an operation of the at least one network node as a network node of the wireless communication network which also comprises a permanent network-service device, such as for example a permanent gateway device, or one or more network-service devices currently connected, and thus being currently part of the wireless communication network. In this embodiment, in the second operation mode, the at least one network node is in communication with both the permanent network-service device and with the one or more network-service devices, which are configured to act as an ephemeral network-service device for providing a respective functionality to the network. Alternatively, in another embodiment, the at least one network node of the wireless communication network is configured to interrupt or pause communication with the permanent network-service device or with any other network-service device currently forming part of the wireless communication network while operating in the second operation mode. Thus, a network node can operate in the first operation mode with respect to a first network-service device which is currently not available and operate simultaneously in a respective second operation mode with respect to one or more available network-service devices.

The communication protocol used to communicate within the wireless communication network is in one embodiment the same communication protocol used to communicate with the network-service device in the second operation mode. In another embodiment, the communication protocol used to communicate within the wireless communication network is different from the communication protocol used to communicate with the network-service device in the second operation mode.

In an embodiment, the first and the second operation mode are defined for a given network-service device. For instance, detecting a first network-service device may trigger operation of a given network node in the second operation mode, allowing a connection within the wireless communication network between the network node and the network-service device. If a second network-service device also becomes available, the network node is considered to be operating in the first operation mode with respect to the second network-service device until a corresponding first switch-mode signal is provide and the network node changes its operation mode based thereon. It is worth noting that the provision of the first switch-mode signal is not necessarily coupled to a change in the operation mode, as it is only an indication of an instruction to switch the operation mode of the at least one network node from the first operation mode to the second operation mode which can be overruled by the network node in certain cases.

In another embodiment, the ascertainment of availability of a given network-service device that is configured to perform one or more of a set of multiple possible functionalities in communication with the at least one network node, gives rises to one of a plurality of second operation modes associated with that network-service device. The second operation mode thus depends on the current functionality that the network-service device is configured to perform within the wireless communication network.

The operation of the node-control unit is in particular embodiments independent on the connection history of the network-service device, i.e., whether or not the network-service device was previously connected to and thus had joined the wireless communication network in the past, before disconnecting from it to assume a current status as external to the wireless communication device. Thus, while the service-availability signal received by the node-control unit may in these embodiments be indicative of the network-service device intending to either join for the first time or re-join the wireless communication network, the response of the node-control unit with regard to operation-mode setting of the network nodes is the same in both cases. In alternative embodiments, the operation of the node-control unit is dependent on the connection history of the network-service device.

In a particular embodiment, the network-service-detection unit, for ascertaining whether or not a network-service device is currently available for communication with at least one of network node of the wireless communication network, is configured to determine whether the network-service device is currently requesting to join the wireless communication network. The network-service device may for instance be announcing its current availability in accordance with a predetermined communication protocol. In a particular embodiment the node-control unit is configured to use the following non-limiting examples of signaling by the network-service device as an indication that a network-service device is currently available: a device announce, a many-to-one route request, a devices or services discovery command, any communication from a device with a particular address, HW (e.g. IEEE address) or network, an appearance of a devices with predetermined capabilities (e.g. interfaces, clusters, roles, etc.), a broadcast of a command indicative of a presence as a network-service device, etc.

Alternatively, or additionally, in another embodiment, the node-control unit is configured to perform a search for available network-service devices within reach. This is performed, in one embodiment, using the communication protocol of the wireless communication network, using the following non-limiting examples: sending device or service discovery commands (e.g. in case of Zigbee: IEEE_address_request, Nwk_address_request, match description request, etc.), route request, or any keepalive mechanism. In another, particular embodiment, by using a communication protocol different from the communication protocol used by the network nodes to communicate within the wireless communication network. As a non-limiting example, an embodiment of a node-control unit is configured to communicate with the network nodes in accordance with a Zigbee communication protocol and, on the other hand, to search for available network-service devices using Bluetooth Low Energy (BLE).

In order to increase the security of the network, in a preferred embodiment, the operation-mode setting unit is further configured to ascertain service-allowance information indicative of network-service devices that are capable of connecting to at least one network node e.g. of performing a gateway function for connecting one or more network nodes of the wireless communication network with network nodes of a different communication network and that are network-service devices allowed to join the wireless communication network. The network-service devices do not necessarily have to be configured to assume a gateway function for connecting the wireless communication network to another different communication network. In some embodiments, the network-service device is configured to run autonomously. The operation-mode setting unit is also configured to determine, using the ascertained service-allowance information, whether the one or more network-service devices currently available for communicating with at least one of the network nodes of the wireless communication network are network-service devices allowed to enter the wireless communication network and to provide an allowance signal indicative of the determination made. In this particular embodiment, the operation-mode setting unit is configured to provide the first switch-mode signal also in dependence on the allowance signal.

The service-allowance information is, in some embodiments, indicative of a connection state of the network-service device to other wireless communication devices or wireless communication networks, so that the availability of the network-service device depends on the current number of connected wireless communication devices or wireless communication networks. For example, a network-service device is considered to be available if it is connected to a number of communication devices or wireless communication network lower than a predetermined threshold amount.

In an embodiment, the operation-mode setting unit is further configured to provide the first switch-mode signal in dependence on a current network capacity. A capacity ascertainment unit is configured to ascertain the current network capacity. If there is no spare capacity left at a given moment, for a given functionality of the network-service device, for instance for a peripheral gateway which wants to extract statistical occupancy data from the network for data analytics purposes, then the first switch-mode signal is not provided and the network nodes continue to operate in the first operation mode until the network has a larger capacity.

For instance, in an embodiment, the operation-mode setting unit has access to a list of allowable network-services which form the service-allowance information, and that is based for example on a respective security key, security certificate, address information, configuration (including interface or communication technology over which the request is made, capability of the network services device, type of the network-service device, functionality made available by the network-service device), spatial location of the network-service devices, etc. Requests originated from network-service-devices not included in the list or not fulfilling the criteria specified in the list, and therefore not allowable would not be granted entrance in the wireless communication network.

In another embodiment the functionality of a network node operating in the second operation mode depends on a type of network-service device detected. For example, in an embodiment, the second operation mode of the network node differs when the wireless communication network includes a network-service device with particular characteristics (e.g. a third party gateway, not offering all the required services), and when the wireless communication network includes a network-service device with another set of characteristics (e.g. vendor own gateway with full set of services).

Further, the network-service device is in a particular embodiment represented differently on the wireless communication network, depending on its capabilities, e.g. a vendor-own gateway is shown with all its services, whereas for a third party gateway, only some services would be available (e.g. only update but not diagnostics).

Alternatively, or additionally, the network-service device is represented in the wireless communication network as a separately addressable device or virtual device on that network, or as a number of virtual endpoints on the network.

Further, in another embodiment, the operation-mode setting unit is additionally configured to monitor an amount of network node currently operating in the second operation mode and to control a maximum number of connections to the network-service device in dependence on the network-service device detected. For example, a third party network-service device could only be allowed to have a maximum number of connections, e.g. one or two at a time, to respective network nodes of the wireless communication network.

In another embodiment, that can also include any of the features of the embodiments described above, the network-service-detection unit is additionally configured to determine whether at least one of the network-service devices is currently connected to the wireless communication network and to provide a respective service-connected signal indicative thereof. In this embodiment, the operation-mode-setting unit is configured to provide to at least one of the nodes of the wireless communication network, via the output interface, a second switch-mode signal indicative of an instruction to switch the operation mode of the at least one network node from the second operation mode with respect to the given network-service device to the first operation mode when the service-connected signal is indicative of the fact that the given network-service device is currently not connected to the communication network.

The determination that the network-service device is not currently connected is performed, in a particular embodiment, based on a predetermined criterion, such as, for instance, when a predetermined amount of the frames sent to any of the known network-service devices, e.g., ⅔ of a total amount of last 100 frames, are lost.

In another embodiment, the operation mode-setting unit is also configured to provide the second-switch mode signal after a predetermined time span from the determination of the absence of the network-service device, thus allowing for a time delay between the determination that no network-service device is currently connected to the wireless communication network and the provision of the second switch mode signal. Also, when the network-service device is configured to provide before leaving the wireless communication network a farewell-signal indicative of an expected or imminent disconnection, an embodiment of the node-control unit is configured to provide the respective second-switch mode signal upon reception of the given farewell-signal.

Alternatively, or additionally, in another embodiment, the operation mode-setting unit is configured to provide the first switch-mode signal after a predetermined time span from the reception of the service-availability signal, thereby reducing the risk of unstable connections to the network-service device.

Advantageously, the predetermined time span from the determination of the absence of the network-service device and from the reception of the service-availability signal are selected based on monitored network stability after connecting and disconnecting a network-service device to and from the wireless communication network respectively, and accounts for the time window in which the connection between the network-service device and the wireless network node is expected to be unstable.

Yet, in another embodiment, during the predetermined time spans referred to above, the communication of a given network node is both distributed with regard to communication with the other network nodes, and directly with the network-service device with regard to communication of the given network node with the network-service device. Thus, the given network node is operable in both operation modes simultaneously. Alternatively, or additionally, during the predetermined time spans the network nodes are operated in the first operation mode while the usage of services from the network-service devices are enabled or disabled.

Another embodiment of the node-control unit of the first aspect of the invention further comprises a node-identification data ascertainment unit configured to ascertain node-identification data indicative of at least one of the one or more of the network nodes that currently form part of the wireless communication network and a storage-unit configured to store the ascertained node-identification data. The node-control unit further comprises a network-service-device update unit configured to provide the stored node-identification data to the network-service device upon receiving a predetermined enabling instruction. In a particular embodiment, the network-service-device update unit is configured to push the network-operation data to the network-service device. In another embodiment, the network-service-device update unit is configured to provide the stored network-operation data upon receiving the predetermined enabling instruction from the network-service device.

In a particular embodiment, the node-identification data ascertainment unit is configured to ascertain node-identification data pertaining to one or more preferred network nodes of the wireless communication network for connecting to the network-service device. The one or more preferred network nodes of the wireless communication network are preferably those network nodes having the most suitable characteristics for communicating with the network-service device. Suitable characteristics include, for example, transmission and reception characteristics associated with the hardware and/or software of the network node, such as antenna parameters (e.g., frequency band, gain) or software driver version, but also characteristics related to the location of the network node (e.g., position within a room or building) or to the respective environment (e.g., presence of walls or objects near the network node), which may also affect the communication capabilities of the network node. Other suitable characteristics include a storage capacity, e.g., for storing an update file, that is currently available in the network node, an amount and/or type of data collected from other network nodes in the wireless communication data network that is currently stored in the network-node and that is available for readout. For instance, for performing a network-diagnosis function, the network-service device preferably communicates with that or those network nodes that have gathered the most relevant information from the other network nodes. Another suitable characteristic includes available routes to/from other network nodes, for instance as routing tables in Zigbee. For example, for performing update function of multiple network nodes, the network-service device preferably provides the update file to that or those network nodes which have a most favorable routing table.

For example, the node-data includes, in an embodiment, a recommendation to which of the network nodes a network-service device should connect to for maximum reliability of a wireless connection, e.g. a BLE connection, between the network-service device and the network nodes, which can also be in accordance to another communication protocol such as Zigbee.

In an embodiment, the node-identification data ascertained and stored includes a list of network nodes of the wireless communication network, comprising, for example, relevant network node ID's and information including application information such as network node names, location information pertaining to an installation location of the respective network node, for instance in the form of tags or labels associated to the network nodes or to a group of network nodes, dedicated functions of the respective network nodes, such as for instance a lighting function, or sensing function, etc.

In another embodiment, the node-control unit additionally or alternatively comprises a network-operation data ascertainment unit that is configured to ascertain network-operation data indicative of communication processes between the network nodes and a first network-service device that is connected to the wireless communication network. The node-control unit also comprises a storage unit configured to store the ascertained network-operation data. In this particular embodiment, the network-service-device update unit is configured to, upon receiving a predetermined enabling instruction, particularly from a second network-service device different than the first network-service device or from the first network-service device, to provide at least part of the stored network-operation data to the second network-service device. For instance, if the second network-service device is in a different area of the network and/or has different capabilities or functions than the first network-service device, the network-service-device update unit is configured to filter out the stored network-operation data and to provide only that part of the stored network-operation data that is intended for the second network-service device. For example, the second network-service device is configured to collect temperature data. The network-service-device update unit thus provides to the second network-service device the network-operation data pertaining to those network nodes acting as temperature sensors.

In another embodiment, the network-operation data ascertainment unit is configured to store information obtained from the first network-service device and then provide this information to the second network-service device. For example, information about conflicts and conflict mitigation strategies between a first and a second network-service device, which for instance may be different models, or even from different vendors and not able to directly communicate with each other, may be provided by the node-control unit to the second network-service device. This sharing is beneficial to arbitrate problems associated with two different network-service devices wanting to communicate with the same network nodes.

A second aspect of the present invention is formed by a network node, which comprises a node-control unit according to any of the embodiment of the first aspect of the present invention and a node-operation unit operable in the first and the second operation mode. The node-operation unit configured to receive the first switch-mode signal from the node-control unit and to operate in the first operation mode or in the second operation mode in dependence thereon.

The network node of the second aspect thus shares the advantages of the node control unit of the first aspect of the invention.

In the following, embodiments of the network node of the second aspect of the invention will be described.

In an embodiment, the node-operation unit, when operating in the second operation mode, is configured to perform one or more of the following functions:

a commissioning function of at least one node of the wireless communication network;

a node-validation function for validating a proper connection of at least one node to the wireless communication network;

a configuration-validation function for validating a proper configuration of at least one node of the wireless communication network;

a software update function for updating a software used by at least one node of the wireless communication network;

a firmware update function for updating a firmware used by at least one node of the wireless communication network;

a fine-tune configuration function for adjusting operation parameters of at least one node of the wireless communication network in the first and in the second operation mode;

a network node-usage monitoring function, for determining, during a predetermined time span, and providing a node usage information quantity indicative of a cumulated time of operation of at least one node of the wireless communication network;

a network-operation monitoring function for determining, during a predetermined time span, and providing a network operation information quantity indicative of an error-rate of communication within the wireless communication network;

a node-operation testing function, for testing a predetermined operation functionality of at least one of the nodes of the wireless communication network;

a network cyber-security monitoring function for monitoring traffic patterns within the wireless communication network and detecting target traffic patterns indicative of a presence of a rogue node in accordance with a predetermined rogue-node detection algorithm;

a presence-sensing function for sensing presence of a subject in a presence-sensing volume associated to the wireless communication network the presence sensing function including determining received signal-quality indicator values. Suitable signal-quality indicator values include received signal strength indication (RSSI) of RF signals transmitted within the wireless communication network), a number of retries needed to convey the signal to the intended network node in case of errors, channel state indicator values (CSI) of a communication link of the wireless communication network or other known signal-quality indicators;

a remote-access function for allowing remote access to the network node by an external device;

a network-information provision function for ascertaining and providing network-information pertaining to the network nodes currently forming part of the wireless communication network;

a position determination function, for determining an approximate position of the network-service device;—a network-node addition function, for connecting one or more external nodes to the wireless communication network; and

an asset-tracking function, for tracking location of one or more target devices using beacon signals provided by the target devices in accordance with a predetermined communication protocol.

Thus, different embodiments of a network node according to the second aspect can perform one or more of the following tasks in communication with the network-service device. For example, the network node can, in cooperation with the network-service device, perform a commissioning function including one or more steps of a commissioning procedure such as validation of proper node installation and location, network formation, network joining, network management, node and/or service discovery or network node configuration.

Also the node-validation function and the configuration validation function can be performed in cooperation with the network-service device while operating in the second operation mode. For example, the network-service device may instruct the network node to check the software version of the nodes of the wireless communication network and provide a report to the network-service device.

In another embodiment, operation in the second operation mode also enables to perform a software or a firmware update to ensure that the network nodes of the wireless communication node have been correctly initialized, e.g., to ensure an initial over-the-air update (OTAU) of the network nodes. For example, network nodes may be installed and commissioned after having spent multiple months on the shelf, and thus with outdated software. Also, a specific firmware version, for example with dedicated functions, may be needed for a specific installation but not available in the general firmware programmed in the ‘stock’ version. As an example, some features might not be included in the ‘stock’ version but only programmed on-site of the customer who has requested this optional feature. As another example, a network node may have different features depending on an environment in which it is operating, e.g. a warehouse or an office.

While operating in the second operation mode, an embodiment of the network node, in cooperation with the network-service device is advantageously configured to make sure that those initial updates are installed, reliably and quickly. Doing such OTAU of all or at least of the relevant network nodes by an installer's device may take too long, since the installer is forced to dwell long on-site for the OTAU (for multiple and potentially many devices) to finish, which is costly and inefficient. Also a particular installation or site may contain for instance some third party network nodes with a functionality not supported e.g. a third-party light sensor, performing threshold-based light level reporting, rather than indicating exact measured light level; occupancy sensors sending directly on/off commands, rather than occupancy events, etc. Discovering those discrepancies enables the provision of a fix, as a software update and/or as a change in the configuration file or rule engine, of the corresponding network nodes, to enable the intended system behavior.

In the particular case of the fine-tune configuration function, a network node such as a wirelessly controlled lighting device can for instance be tuned to adapt parameters such as light reaction times or default light level based on user feedback, e.g. based on user age, task type performed in a particular space, color of the space furnishing/finishing, etc. This can also be advantageously used to assist end-users on first days of usage to fine-tune the system via remote-access trouble shooting by the installer and thus removing the need for the installer to travel to the site again.

In the particular case of a network-operation monitoring function, the network node can, in cooperation with the network-service device monitor network operation for a predetermined time span; for example, in case frequently breaking radio links in a particular location are detected, a user is informed of possible improvements such as an addition of routers range extenders, or re-positioning of existing network nodes, or an adaptation of transmission power or changing of an operational channel or changing node communication patterns. Also energy usage data can be determined over a period of time and then provided to the network-service device during operation in the second operation mode.

A network node performing a network-usage monitoring function for monitoring network usage during a predetermined time span can advantageously be used for instance to help the device vendor and/or system integrator learn about the difficulties the users are facing with the default systems setup, so that the defaults can be improved in subsequent installations. For example, the vendor could keep the network-service device in a first room where network nodes are being installed, so that the changes applied post-installation can be part of the default setup of the rooms installed later on, on the same or different site. The vendor could store the information in configuration files or profiles, e.g. per customer or use case. This function can also be performed to other network parameters such as the stability of routes, which can be determined over a predetermined period of time. Also aggregated occupancy data can be determined over a period of time and then provided to the network-service device during operation in the second operation mode.

The node-operation testing function includes one or more tests to be performed on the nodes of the network, including for example, battery backup test, sensor coverage test, radio coverage tests, calibration tests, etc.

A network node performing the network cyber-security monitoring function is advantageously configured to, for example, detect unusual traffic patterns in the network that can be indicative of a rogue network node and referred to as target traffic patterns. It can also be configured to detect if a 3^{rd} party network-service device, such as a gateway device, gets rogue due to hacking e.g. an HVAC network-service device suddenly requesting occupancy data at a higher frequency than originally expected, the typical HVAC application thinks in granularity of several minutes before adjusting the HVAC setting to occupancy of a room, or a network-service device asking for data which is not relevant to it. A particular and non-limiting example thereof is a HVAC gateway sending software updates to lighting nodes.

An embodiment of the network node is configured to perform, in cooperation with the network-service device, a presence-sensing function for sensing presence of a subject in a presence-sensing volume associated to the wireless communication network; the presence sensing function including determining received signal strength indicator values of RF signals transmitted within the wireless communication network or determining a channel state indicator of a communication link of the wireless communication network. For instance, the network node can perform highly granular RF-sensing, which may also include a people-counting function, which adds to the network load and power consumption of the network nodes involved. If the network-service device is not present, the network nodes can be configured to fall back to a basic functionality such as, for example, RF-sensing only for occupancy detection or soft-security, and terminate all activities related to the network-service device requiring use cases. In an embodiment, this is performed in dependence on the network-service device type, e.g. if it is a smartphone, the fact of the presence of such network-service device is used to augment the information about the presence sensing or people counting. For example, presence of a smartphone gateway, particularly a moving one, suggests a presence of a person in that location.

Alternatively, in another embodiment, the highly granular RF-sensing is disabled when the network-service devices is present, e.g. because then the system can rely on other modalities for people counting, e.g. on the camera in the network-sensing device, or because the traffic intense operation is stopped or reduced to free bandwidth for any communication required by the network-sensing device.

A network node performing a network service device-position determination function, for determining an approximate position of the network-service device is configured to, in cooperation with other nodes of the network, to detect the location of the network-service device, for instance using trilateration with Bluetooth. If the determined position is far from an expected position, then a warning signal is issued since this can be indicative of a hacked device trying to access the communication network, for instance from outside a building where the communication network is located.

Typically, a location engine of Bluetooth Low Energy (BLE) or ultra-wide band (UWB)-based asset tracking of target devices is computationally intensive and hence is advantageously run in cooperation with a network-service device. Asset tracking refers to the method of tracking physical assets, such as target devices for instance based on the use of tags using GPS, BLE or RFID which broadcast their location. These technologies can also be used for indoor tracking of persons wearing a tag. For indoor asset tracking Wi-fi combined with another technology like infrared (IR) has been used. Bluetooth technology has also been used, and may provide more accuracy even if Bluetooth technology was not primarily developed for localization. In order to position an asset via Bluetooth, which is a basic requirement for asset tracking, the RSSI or CSI can be used to calculate a distance to the target device from the signal strength. The principles for position determination are trilateration, triangulation and fingerprinting.

According to a third aspect of the present invention, a wireless network-service device is described. The wireless network-service device is suitable for operation in one or more different wireless communication networks. The network-service device is configured to switch operation between a first service operation mode and at least one second service operation mode. The first service operation mode corresponds to the network-service device being currently available for communication with at least one node of a target wireless communication network to which the network-service device is not currently connected. The at least one second service operation mode corresponds to the network device being currently available for communication with at least one node of a target wireless communication network to which the network-service device is currently connected.

The wireless network-service device comprises a wireless communication unit configured to receive and/or provide wireless messages from and to network nodes belonging to the one or more wireless communication networks to which the wireless network-service device is communicatively connected. It further comprises a network-connection control unit configured to determine that at least one network node of the target wireless communication network is currently in a first operation mode as a network node of the target wireless communication network in a first network configuration, which excludes the network-service device from the target wireless communication network or in a second operation mode as a network node of the target communication network in a second network configuration, which includes the at least one network-service device in the target wireless communication network and to wirelessly communicate with the network nodes of the target wireless communication network that are currently operated in the second operation mode. Thus, the network-service device is configured to determine if there are network nodes of the target wireless communication network operated in the second operation mode and to communicate with them, thereby joining de facto the target communication network.

In the following, embodiments of the wireless network-service device of the third aspect will be described.

In an embodiment, the network-service device is configured to perform one or more of a set of multiple possible functionalities in communication with the at least one network node. This gives rises to one of a plurality of possible second service operation modes associated with that network-service device. The second service operation mode thus depends on the current functionality that the network-service device is configured to perform within the wireless communication network.

In a particular embodiment, the network-service device comprises a node-control unit in accordance with the any of the embodiments of the first aspect of the present invention. In this particular embodiment, the network-service device is configured to control the operation mode of one or more of the network nodes of the wireless communication network. In particular, the network-connection control unit is connected to the operation-mode setting unit which provides the first switch-mode signal, and the provision of the first switch-mode signal is interpreted as an indication that at least one network node of the target wireless communication network is currently operating in the second operating mode. In an embodiment, the network-connection control unit is additionally configured to receive, via an input interface, a connect-signal indicative of an instruction to connect to the target wireless communication network to which the wireless network-service device is not currently connected. It is also configured to provide via an output interface, and to at least one node-control unit in with the first aspect of the invention, a connect-request signal indicative of a request for acceptance in the target wireless communication network. Upon connecting to the target wireless communication network, the network-service device is configured to communicatively cooperate with one or more network nodes of the target communication network for operation in the second operation mode. This particular embodiment of the wireless network-service device of the third aspect is advantageously configured to communicate with the node-control unit of the first aspect of the invention, particularly with those embodiments of the node-control unit which are configured to ascertain whether one or more network-service devices are currently requesting acceptance for communicating with at least one network node of the wireless communication network.

In an embodiment, the input interface is connected to the wireless communication unit. The connect-signal is in this embodiment a wireless signal transmitted from one of the wireless communication networks to which the network-service device is currently connected.

In another embodiment, the input interface is alternatively or additionally connected to a user interface, such as a button or actuator, and the connect signal is a response to a user actuating the user interface.

In a particular embodiment, the network-service device is further configured to perform in communication with one or more network-nodes of the second aspect of the invention operating in the second operation mode, one or more of the following functions:

a commissioning function of at least one node of the wireless communication network;

a node-validation function for validating a proper connection of at least one node to the wireless communication network in accordance with a predetermined connection criterion;

a configuration-validation function for validating a proper configuration of at least one node of the wireless communication network in accordance with a predetermined configuration criterion;

a software update function for updating a software used by at least one node of the wireless communication network;

a firmware update function for updating a firmware used by at least one node of the wireless communication network;

a fine-tune configuration function for adjusting operation parameters of at least one node of the wireless communication network in the first or second operation mode;

a network node-usage monitoring function, for determining, during a predetermined time span, and providing node usage information quantity indicative of a cumulated time of operation of at least one node of the wireless communication network;

a network-operation monitoring function for determining, during a predetermined time span, and providing a network operation quantity indicative of an error rate of communication within the wireless communication network;

a node-operation testing function, for testing a predetermined operation functionality of at least one of the nodes of the wireless communication network;

a network cyber-security monitoring function for monitoring traffic patterns within the wireless communication network and detecting target traffic patterns indicative of a presence of a rogue node in accordance with a predetermined rogue-node detection algorithm;

a presence-sensing function for sensing presence of a subject in a presence-sensing volume associated to the wireless communication network the presence sensing function including determining received signal quality indicator;

a remote-access function for allowing remote access to the network node by an external device;

a network-information provision function for ascertaining and providing network-information pertaining to the network nodes currently forming part of the wireless communication network;

a position determination function, for determining an approximate position of the network-service device;—a network-node addition function, for connecting one or more external nodes to the wireless communication network; and

an asset-tracking function, for tracking a location of one or more target devices using beacon signals provided by the target devices in accordance with a predetermined communication protocol.

In different variants implementing the presence-sensing function, the signal quality indicator includes at least one of RSSI value of RF signals transmitted within the wireless communication network, a channel state indicator of a communication link of the wireless communication network such as a number of retries needed to convey a control or payload information to the intended network node in case of errors, or other suitable signal-quality indicators.

A network-service device in accordance with the third aspect can advantageously be used as an ephemeral gateway, for instance during installation, commissioning and/or maintenance of a wireless communication network.

In one embodiment, the ephemeral wireless network-service device, particularly a gateway device, is a dedicated box with a wireless automation interface and an interface for Internet connection. Alternatively, a resource-rich on premise network-service device with a user interface and pre-stored content, e.g. software images for a large range of devices, which however is not Internet connected, may be used as ephemeral network-service device. The network-service device is temporarily present during some installation, commissioning and/or maintenance actions, and can be physically removed from the network at other times, e.g., to limit the network cost or to be used at another location. For instance, the network-service device may be a Cradlepoint router with a high-power cellular radio to ensure connectivity even in areas where smartphones have reception issues.

In another embodiment, the functionality of the network-service device is enabled via the automation devices, e.g. by the automation device connecting to a portable device such as a smartphone, a laptop or a tablet, e.g. via BLE, and an application on the portable device providing access to the relevant functions and/or content at the time of installation, commissioning and/or maintenance, including for example OTA upgrades. Once those actions are finished, the gateway functionality can be disabled, e.g. to prevent attacks from the Internet or to reduce cost associated with internet connectivity. The functionality may also be deactivated by removing the portable device from the network, either physically or logically by disconnecting it from the wireless communication network.

For wireless communication networks configured to be operated as standalone networks, the ephemeral network-service device is suitably configured to provide access to Internet-based services without the up cost of a permanent network-service device. The network-service device is Internet connected or may also work without Internet connection, with content down- and uploaded at other times or via other means.

If the ephemeral network-service device, e.g. on a smartphone, needs to connect to a network node on the to-be-joined or target communication network via another interface, e.g. BLE or NFC, that network node selected for connection will be referred to as active proxy node.

Another possible implementation of the network-service device is a drone or a robot e.g. similar to the connected robotic vacuum cleaners available in the market. These network-service devices have an interface to connect with the outside world or building network e.g. a 3G/4G network connection, Wi-Fi connection or a wired connection, e.g. through powerline or Ethernet, e.g. available when it is docking/charging, through which it gets controlled and reports to the network owner. It also includes another interface that allows it to connect to the wireless communication network, to install, check and/or update their configuration, or perform some diagnostics or OTA updates. The network-service device can operate one interface at a time, e.g. get a task via the owner interface, disconnect, perform whatever it was tasked with in the lighting control network and leave the network again, and—if required—connect to the owner interface again and report the results. Additionally, or alternatively, the network-service device allows real-time connection between the wireless communication network and the owner interface, e.g. allowing a human operator to perform checks and take actions. The network-service device is suitable to be used on demand, i.e. remain disconnected from the wireless communication network until explicitly instructed to perform a particular task. It could also roam around within reach of the communication network, constantly or periodically checking the network's health.

Another implementation form is to mount the network-service device on a cleaning trolley, coffee maintenance trolley, security guard equipment, etc. which accomplishes it will visit all location i.e. all communication networks in a building in the course of a few days.

In another embodiment, the network-service device is configured to remain in the wireless communication network for a predetermined amount of time or until a given number of predetermined functions is completed. In an embodiment, the network-service device is configured to provide a farewell signal to the node-control unit, the farewell signal being indicative of an instruction to remove ephemeral information not relevant to the operation of the network nodes in the first operation mode and, in the case that the network-service device is intended to rejoin the wireless communication network at a later point in time, to delete that information not relevant for the next time it would be rejoining, e.g. any bindings required for specific tests or maintenance tasks, etc.

There are several implementations of this for the “gateway for a limited time” concept. For example, a wireless communication network is installed using the network-service device but operated as a standalone network later. There are several scenarios where such an approach is beneficial. For instance, in cases where the network-service device is costly and/or contains valuable functions that should not be left in-site for a long time, due to, e.g., risk of IPR-theft, the gateway-device is preferably just lent or provided by the installer for installation and system-startup.

Another scenario is related to external security risks. For example, an owner or user of the wireless communication network may be worried about attacks on the wireless communication network coming from the internet, hence insist that the wireless communication network is operated in standalone mode once normal operation has started after the system start-up phase. However, the owner wants to allow the installer to operate the system in the cloud-connected mode for a brief initial period after installation or during trouble shooting using a so called ephemeral gateway-device, so that the installer can remotely troubleshoot and fine tuning of the system. Also, the owner may be worried, that the network-service device itself, even without connection to the internet, may be stolen or hacked, thus exposing some data about the network or its users. In another scenario the owner or user may be worried about the additional complexity of the system by having an extra controller in the form of gateway-device, with potentially unlimited control rights,—or worry about the complexity of the combination of the distributed local control (e.g. based on switch and/or sensor input and/or pre-programmed schedules) and an override via gateway device, or worry about fulfilling device operational conditions (e.g. battery life of battery-powered devices) or service level agreements or regulation compliance (e.g. guaranteeing the required minimum light level on a work surface in an office or a factory).

The network-service-device of the third aspect is, in a particular embodiment, implemented via a dedicated smartphone or tablet, and may include a dongle. The network-service device is configured to act as an ephemeral network-service which is then suitable to be returned shipped to the installer after an initial phase.

Similarly, in case of later trouble or need for system modification, a network-service device can be provided by, for instance, the installer to the site and put on site by the facility manager. Then the installer can do remote diagnostics of the issues at hand. Alternatively, the installer can bring the network-service device while doing house calls.

A similar functionality could be implemented by an app on the facility manager's smartphone which is remotely enabled during the period when it is needed—and for functionality that is appropriate to the task at hand. The app could only have authorization to execute selected functions (e.g. network diagnostics, but not network reconfiguration). Alternatively, a variant of the app can be uploaded that only provides the necessary functionality blocks.

In these cases, the use of public key certificates with very short lifetime and/or clearly defined permissions is beneficial.

In a particular embodiment, the network-service device is a high capability Building Management System (BMS) integration gateway with BACnet interface suitable to efficiently install or update the wireless communication network. The high-capability BACnet gateway may be used to retrieve, for example building data from an HVAC gateway, including e.g., layout data of the building with room names, in order to have speed up the set-up of a lighting system as the wireless communication network. The high-capability BACnet gateway could, on explicit user wish, be used for integration between different building verticals, e.g. lighting, HVAC, security & safety.

After installation an embodiment of the gateway-device is configured to remain in the network, but with reduced functionality. For instance, after the installation tasks for the first days mentioned above are completed, the gateway-device is configured to go into a “monitoring” mode where it only monitors the activity in the network and e.g. reports anomalies to the installer and/or the facility manager, while otherwise remaining silent. This reduces the communication cost of the upward gateway communication and also reduces the complexity of the control traffic in the system.

Alternatively, an embodiment of the network-service device is configured to remain in the network, but with its uplink completely disconnected; only performing the network-bound functions, e.g., complex controls. Disconnecting the network-service device from the Internet allows to limit the perceived threat of attacks originating from the Internet. The network-service device can however be subsequently activated for instance as a pilot for some enhanced features. This way, the users can experience for a limited period of time, the behavior they consider enabling before they really make a decision. Being able to enable it quickly and painlessly, potentially even remotely, can be a major enabler for services in wireless communication networks, especially in lighting networks. Enabling the enhanced features through a gateway, e.g. keep the application logic related to the feature in the cloud, may help protecting the related IPR and/or trade secrets, since the code enabling that functionality doesn't need to be pushed into the network or even the gateway.

Different embodiments of the network-service device have different approaches on when, how or to which extent the corresponding network-service device is removed from the wireless communication network.

In an embodiment, the network-service device is configured to auto-disconnect once the OTAU has been done, even when the gateway remains on premise.

In another embodiment, the network-service device is configured to auto-disconnect autonomously at a predetermined point in time after installation is completed and the wireless communication network is running satisfactorily.

Additionally, or alternatively, in another embodiment of the network-service device, if a power outage is detected, for example if a user, installer or facility manager removes the network-service device physically from power, the network-service device is configured to stay disconnected during a predetermined time amount so that it cannot be reconnected and thus to prevent an unauthorized usage.

In another embodiment, the network-service device is configured to be disabled after a given time span but is configured to be used as a lifeline upon request, for instance in case of problems, via remote activation or some dedicated code that the installer helpdesk can give to the user of the facility manager to activate the network-service device. Alternatively, the network-service device comprises a user interface that can be activated or actuated by a user to start remote maintenance, i.e. to request entrance or permission to join the wireless communication network.

In another embodiment, after the initial period, the network-service device is configured to communicate with an external server but does not upload anything unless instructed by local intervention of the facility manager, e.g., by adding a certain code sent to the building owner by the installer or pushing a button on the device. Hence, a particular embodiment of the network-service device may only report unusual network behavior indicative for instance of a security breach, networking overload issues, devices reporting error states, etc. Also, preferably, OTA security updates require action by a user or owner to enable the actual update, e.g. physical button press on gateway, or access code as described above.

In another example, a standalone wireless communication network is at first installed by a professional installer using a network-service device as an ephemeral gateway. Subsequently, the end-user requires troubleshooting by the installer. As the wireless communication network has already been installed with an ephemeral gateway, a troubleshooter network-service device can be e.g. snail-mailed to the end-user who self-installs it hence avoiding expensive truck runs. The troubleshooter network-service device is configured with the knowledge of the network parameters, as the system has been set up as an ephemeral gateway and hence the network parameters are available. Hence it can be added to the network without any need of recommissioning or reconfiguration. In the particular case of a wireless communication network based on Zigbee, this requires storing an IEEE address intended for the gateway, assuming it being also a Trust Centre, (short address of the Zigbee Coordinator and the Trust Center is always 0x0000), the corresponding network key, and the EPID (extended PAN) which is usually the Zigbee Coordinator's IEEE address. With those parameters, the wireless communication network should be discoverable via active scan, and the PAN-id and channel and network key update can be derived; alternatively, those parameters can be stored as well. In an embodiment, when the network-service device discovers the presence of the network it was searching for, it is configured to explicitly contact one or more of the network nodes, e.g., by creating a BLE connection to a Zigbee-BLE proxy network node. A detection of an establishment of such a connection of a network node to the gateway is, in a particular embodiment of the node-control unit, a way of ascertaining whether one or more network-service devices are currently available for communicating with one or more network nodes of the wireless communication network.

In another particular example, in a wireless communication network, such as for instance a Hue lighting system, occasionally a new generation of network-service devices gets introduced. Many legacy users must therefore upgrade their old-generation network-service devices to the new version. The old network-service device is configured as network-service device according to the third aspect, acting as an ephemeral gateway in the same network as the new network-service device but with limited rights when upgrading to the new network-service device. Further, some compatible functionality of the new network-service device can be assigned to the old network-service device, which can also be configured to perform a maintenance function such as monitoring the health of the network and/or help in debugging.

A fourth aspect of the present invention is formed by a wireless communication network that comprises at least one node-control unit according to the first aspect of the invention, two or more network nodes comprising an operation unit configured to receive the first switch-mode from the node-control unit and to operate in the first operation mode or in the second operation mode in dependence thereon and at least one wireless network-service device according to the third aspect of the invention.

The wireless communication network thus shares the advantages of the node-control unit of the first aspect and of the network-service devices of the third aspect of the invention.

In the following, embodiments of the wireless communication network of the fourth aspect will be described.

In an embodiment, one or more of the network nodes comprises a respective node-control unit.

In another embodiment, the wireless communication network further comprises a network-control device configured to provide to the at least one network-service device security credential data indicative of an allowance to join the target wireless communication network. In this particular embodiment the network-service device is configured to provide the connect-request signal using the security credential data received.

According to a fifth aspect, a method for operating a node-control unit for setting an operation mode of one or more network nodes of a wireless communication network is presented. The method comprises:

ascertaining that one or more network-service devices, which are currently external to the wireless communication network are currently available for communication with at least one of the network nodes of the wireless communication network and providing a service-availability signal indicative thereof;

in response to receiving the service-availability signal;

generating and to providing a first switch-mode signal indicative of an instruction to switch the operation mode of the at least one network node from a first operation mode of the at least one network node as a network node of the wireless communication network in a first network configuration, which excludes the network-service device to a second operation mode of the at least one network node as a network node of the wireless communication network in a second network configuration, which includes the at least one network-service device.

According to a sixth aspect of the invention, a method for operating a network node is described. The method comprises:

performing the method of the fifth aspect of the invention;

receiving the first switch-mode signal;

operating the network node in the first operation mode or in the second operation mode in dependence of the first switch-mode signal.

According to a seventh aspect of the invention, a method for operating a wireless network-service device for operation in one or more different wireless communication networks is presented. The network-service device is configured to switch operation between a first service operation mode corresponding to the network-service device being currently available for communication with at least one node of a target wireless communication network to which the network-service device is not currently connected; and a second service operation mode corresponding to the network-service device being currently available for communication with at least one node of a target wireless communication network to which the network-service device is currently connected. The method comprises:

determining that at least one network node of the target wireless communication network is currently in a first operation mode as a network node of the target wireless communication network in a first network configuration, which excludes the network-service device from the target wireless communication network or in a second operation mode as a network node of the target communication network in a second network configuration, which includes the at least one network-service device in the target wireless communication network; and

wirelessly communicating with any network node currently in the second operation mode.

In an embodiment, the method additionally comprises receiving a connect-signal indicative of an instruction to connect to the target wireless communication network to which the wireless network-service device is not currently connected. It also comprises providing via an output interface, a connect-request signal indicative of a request for acceptance in the target wireless communication network. Upon connecting to the target wireless communication network, the method comprises communicatively cooperating with one or more network nodes of the target communication network for operation in the second operation mode.

In an embodiment, the wireless network service device is configured to adapt its operation depending on the type of network node it is connecting to. For example, in an embodiment, the wireless network-service device is configured to expose all services and offer full functionality when connected via a vendor-own network node, but only expose basic services when connecting to a third-party network node.

According to an eighth aspect of the invention a computer program is presented which comprises instructions that, when the program is executed by a computer, cause the computer to carry out the method of any one of the sixth or seventh aspects.

It shall be understood that the node-control unit of claim 1, the network node of claim 6, the network-service device of claim 8, the wireless communication network of claim 10, the respective methods for operating a node-control unit, a network node and a network-service device of claims 12 to 14 and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of an embodiment node-control unit in a wireless communication network and an ephemeral network-service device available for connection,

FIG. 2 shows a schematic block diagram of an embodiment wireless communication network and a network-service device,

FIG. 3 shows a schematic block diagram of an embodiment of a wireless network-service device in communication with two different wireless communication networks,

FIG. 4 shows a flow diagram of an embodiment of a method for operating a node-control unit,

FIG. 5 shows a flow diagram of an embodiment of a method for operating a network node, and

FIG. 6 shows a flow diagram of an embodiment of a method for operating a wireless network-service device.

### DETAILED DESCRIPTION OF EMBODIMENTS

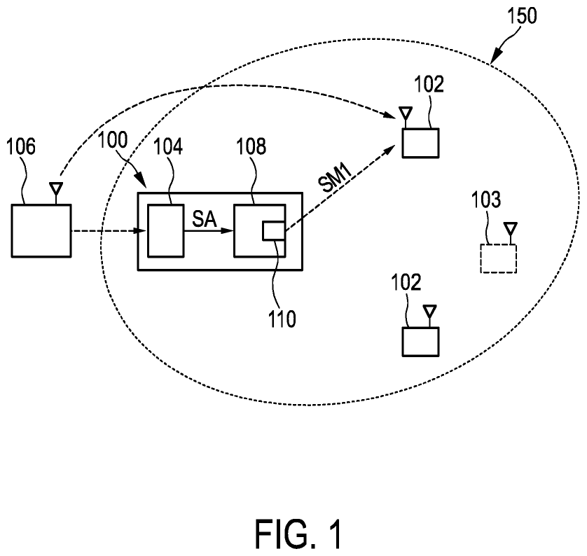

FIG. 1 shows a schematic block diagram of a node-control unit 100 in a wireless communication network 150 and an external ephemeral network-service device 106 available for connection. The node-control unit 100 is suitably configured to set an operation mode of one or more network nodes 102 or 106 of the wireless communication network 150. At least one of the network nodes is configured to operate in a first operation mode OM1 that corresponds to an operation of the at least one network nodes as a network node of the wireless communication network 150 which excludes the network service device 106 and in a second operation mode OM2 which corresponds to an operation of the at least one network node in communication with the network-service device 106, i.e., where the network-service device 106 is part of the wireless communication network.

The node-control unit 100 comprises a network-service-detection unit 104, configured to ascertain whether one or more network-service devices 106, which are currently not part of the wireless communication network, are currently available for entering the wireless communication network, i.e., for communicating with at least one of the network nodes of the wireless communication network, and to provide a service-availability signal SA indicative thereof. The node control unit also comprises an operation-mode setting unit 108 that is configured to control switching of the operation mode of the at least one network node 102 between the first and the second operation mode discussed above. For this purpose, the operation-mode setting unit 108 is configured to receive the service-availability signal SA and, when the service-availability signal is indicative of at least one network-service device being currently available for entering the wireless communication network 150, to provide to at the least one of the network nodes 102 of the wireless communication network 150, via an output interface 110, and in dependence on the service-availability signal SA, a first switch-mode signal SM1 indicative of an instruction to switch the operation mode of the at least one network node 102 from the first operation mode to the second operation mode. Particularly, in this node-control unit, the operation-mode setting unit is configured to determine whether the network-service device 106 providing the request signals is a network-service devices allowed to enter the wireless communication network and to provide an allowance signal indicative thereof. The operation-mode setting unit 108 is also configured to provide the first switch-mode signal also in dependence on the allowance signal, i.e., only when the available network-service device is an allowable network-service device in accordance with a predetermined security criterion, or with a predetermined capability criterion, or with a predetermined performance criterion, etc.

The wireless communication network 150 may be a standalone network or may include a permanent network-service device 103 which is used by the nodes of the network to operate in the first operation mode. The permanent network-service device, for example a permanent gateway device, is thus part of the wireless communication network and not a network-service device as network-service device 106.

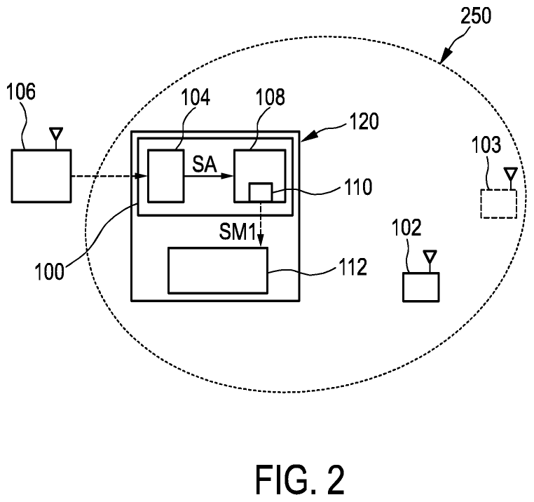

FIG. 2 shows a schematic block diagram of another embodiment wireless communication network 250 and a network-service device 106. The following discussion will mostly refer to those features that are different when compared to the wireless communication network 150 of FIG. 1. In the wireless communication network 250, network node 120 comprises a node-control unit 100 as described with reference to FIG. 1. It also comprises a node-operation unit 112 that is operable in the first and the second operation mode. The node-operation unit is configured to receive the first switch-mode signal SM1 from the node-control unit 100, in particular from the output interface 110 of the operation-mode setting unit 108, and to operate in the first operation mode or in the second operation mode in dependence thereon. In particular, the network node 120, when operating in the second operation mode, is configured to perform one or more of the following functions:

a commissioning function of at least one node of the wireless communication network;

a node-validation function for validating a proper connection of at least one node to the wireless communication network;

a configuration-validation function for validating a proper configuration at least one node of the wireless communication network in accordance with a predetermined configuration criterion;

a software update function for updating a software used by at least one node of the wireless communication network;

a firmware update function for updating a firmware used by at least one node of the wireless communication network;

a fine-tune configuration function for adjusting operation parameters of at least one node of the wireless communication network in the first and in the second operation mode;

a network node-usage monitoring function, for determining, during a predetermined time span, and providing a node usage information quantity indicative of a cumulated time of operation of at least one node of the wireless communication network;

a network-operation monitoring function for determining, during a predetermined time span, and providing a network operation information quantity indicative of an error rate of communication within the wireless communication network;

a node-operation testing function, for testing a predetermined operation functionality of at least one of the nodes of the wireless communication network

a network cyber-security monitoring function for monitoring traffic patterns within the wireless communication network and detecting target traffic patterns indicative of a presence of a rogue node in accordance with a predetermined rogue-node detection algorithm;

a presence-sensing function for sensing presence of a subject in a presence-sensing volume associated to the wireless communication network the presence sensing function including determining received signal quality indicator values such as RSSI values of RF signals transmitted within the wireless communication network or channel state indicator of a communication link of the wireless communication network;

a remote-access function for allowing remote access to the network node by an external device;

a network-information provision function for ascertaining and providing network-information pertaining to the network nodes currently forming part of the wireless communication network;

a position determination function, for determining an approximate position of the network-service device; and

a network-node addition function, for connecting one or more external nodes to the wireless communication network.

Detailed examples of these functions are given above.

In another exemplary wireless communication network (not shown) more than one of the network nodes, and in another example all of the network nodes, comprise a respective node-control unit.

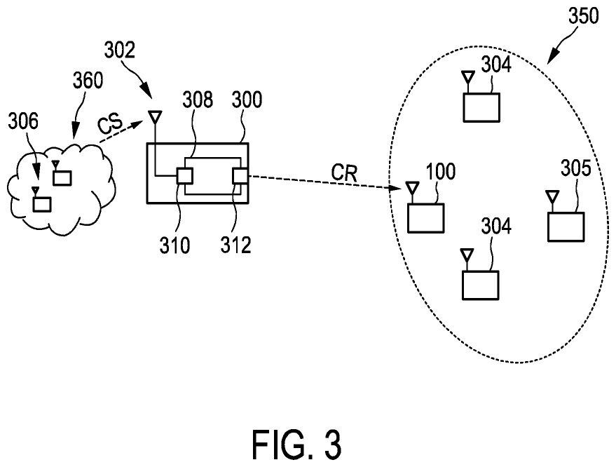

FIG. 3 shows a schematic block diagram of an embodiment of a wireless network-service device 300 in communication with two different wireless communication networks 350, 360. Wireless communication network 360 is, in this particular example the Internet, to which the wireless network-service device 300 is connected via, e.g., a WiFi or a 3G/4G or 5G router. The wireless network-service device 300 comprises a wireless communication unit, such as a transceiver unit 302 that is configured to receive and provide wireless messages from and to network nodes 304, 306 belonging to the one or more wireless communication networks to which the wireless network-service device is communicatively connected. The wireless network-service device 300 also comprises a network-connection control unit 308 that is configured determine that at least one network nodes of the target wireless communication network is currently in a first operation mode as a network node of the target wireless communication network in a first network configuration, which excludes the network-service device from the target wireless communication network or in a second operation mode as a network node of the target communication network in a second network configuration, which includes the at least one network-service device in the target wireless communication network, and to wirelessly communicate with one or more network nodes of the target communication network currently operating in the second operation mode.

In the exemplary network-service device 300 of FIG. 3, the network connection unit 308 is configured to receive, via an input interface 310, a connect-signal CS indicative of an instruction to connect to a target wireless communication network 350 to which the wireless network-service device is not currently connected. In the network-service device 300 the connect-signal is a wireless signal transmitted from the network 360 and received via the wireless communication unit. In an alternative network-service device (not shown), the input interface is a user interface, such as a button or a touch screen or an actuator that the user actuates or operates to provide the connect-signal, which in this particular case is an electrical signal generated inside the network-service device.

The network-connection control unit is also configured to provide, via an output interface 312, and to at least one node-control unit 100 of the target wireless communication network 350, a connect-request signal CR indicative of a request for acceptance in the target wireless communication network. As explained above with reference to FIGS. 1 and 2, the node-control unit interprets the reception of the connect-request signal as an indication that the network-service device 300 is currently available for entering the wireless communication network 350. Preferably, the node-control unit also checks whether the wireless device 300 is trustworthy and should be allowed into the wireless communication network 350. Preferably this is done with the aid of a network-control device 306 that is configured to provide to the network-service device 300 security credential data pertaining to the target wireless communication data 350. The network-service device is then configured to provide the connect-request signal using the security credential data received.

Once the first switch-mode signal is received, the network node switches its operation mode from the first to the second operation mode, for instance to perform any one or more of the functions described above. The network-service device 300, upon connecting to the target wireless communication network, is configured to communicatively cooperate with one or more network nodes of the target communication network for operating the one or more network nodes in the second operation.

The wireless communication network 350 comprises, in addition to the control-node unit 100, further network nodes 304. Optionally, the wireless communication network may comprise an additional network-service device 305, either a permanent network-service device or a second ephemeral wireless network-service device, similar to the wireless network-service device, which is currently also supporting operation of the wireless communication network 350.

Suitable wireless communication networks include, but are not limited to lighting networks comprising lighting nodes and sensors controllable via a suitable wireless communication protocol such as, but not limited to Zigbee, BLE or WiFi.

The use of peripheral network-service devices is particularly suitable for integration of lighting systems with, for example, voice control. Currently it is a typical policy of a building infrastructure owner to offer lighting system in combination with voice control. However, while certain office users do want voice control, others do not like to have voice control present in their office due to, for example, privacy concerns. This would require the temporary removal of the voice assistant speaker from the office based on the request of the tenant/user and hence the lighting network. In flexible working areas this may even happen on a daily basis. All the lighting devices may stop all the activities related to the gateway-requiring use cases, e.g. reporting occupancy or energy consumption data once the voice-assistant has left the network.

The combined use of a node-control unit, and a suitable network-service device reduces the complexity of temporarily enhancing a connect-ready system with a gateway for an initial installation, using ephemeral network-service devices on demand for the purpose of reconfiguring or updating the system or temporarily connecting multiple sub-systems/extending an existing lighting system without the need to completely reconfigure the system.

For example, the product lifecycles of voice assistants and wireless lights are typically very different. While lights are configured to remain in the ceiling for over 10 years, often until they break, voice assistants are consumer electronics which are likely replaced by the user to a new device after max. 5 years. Hence, it is important that the user can freely remove or exchange the voice assistant devices over the lifetime of the office lighting or hue DLC (Direct Light Control) installation without affecting the hue DLC core lighting functionality.

Currently, past learnings are lost if the voice assistant, used as a peripheral gateway-device is replaced, certainly if the replacement peripheral network-service device comes from a different vendor. An advantageous node-control unit is suitably configured to store certain information obtained from the original peripheral network-service device and share this information with the replacement peripheral network-service device. For instance, the network node, e.g., DLC lights, may share recommendations to which of the lights of the DLC installation the peripheral gateway should connect to for maximum reliability of the BLE connection between the peripheral gateway and the Zigbee light. In addition, also information about conflicts and conflict mitigation strategies between a first peripheral network-service device and a second peripheral network-service device, which may remain still in place, may be provided by the node-control unit to the new peripheral gateway. This sharing is advantageous as the network-service devices typically do not interact with each other to arbitrate problems associated with two peripheral gateways wanting to control the same lights.

Other network-control nodes are additionally or alternatively configured to share with a connecting ephemeral gateway the list of devices present on the network, with relevant Zigbee ID's and information including application information such as light names, rooms/grouping, dedicated functions, etc.

There may be situations, where the living room of a home features a voice-control device and a first hue DLC lighting system. A second hue DLC system is installed in the adjacent bedroom, where however no voice-control device is present in the bedroom due to privacy reasons. The second hue DLC system may be comprised of a wall switch and two lights and the end-user never uses his smartphone app to control the lighting after the initial setup. The hue application is well aware that in there are two independent hue DLC systems present in the same house, and knows that only the first hue DLC system can be reached via the voice-control device from the cloud. If there is a safety critical firmware update for the lights in the bedroom, the hue system may request assistance from the voice-control device in the living room. In this case, the voice control device may become simultaneously a peripheral gateway of a first hue DLC lighting network and of a second DLC lighting network. The first and second DLC network act as completely independent networks, preferably with different security key and/or channel. In this case, while the voice-control device is upgrading the firmware of the second DLC network, it is still able for voice control, at least with low latency, the first hue DLC lights.

If running the two networks in parallel proves not feasible the voice-control device as a network-service device is advantageously configured to temporarily to join the bedroom network, perform the OTAU, and then return to the original network. Since the OTAU may take some time, this could be run at night, or during the daytime when no one is present.

The lighting devices in the standalone network may behave differently whether or not a network-service device (e.g. voice assistant) is present. For instance, if a network-service device is present, the lights may perform highly granular RF-sensing (incl. people counting), which adds to the network load and power consumption of the lighting devices. If the peripheral gateway is not present, the lighting devices may fall back to the basic functionality (e.g. RF sensing only for occupancy detection or soft-security alone) and stop (or reduce) all the activities related to the gateway-requiring use cases (e.g. people counting or energy consumption data) once the voice-assistant has left the network since there would be no consumer of any such rich data which is collected. The lighting devices may switch mode right after the voice assistant has left the network or continue for a while in the case the peripheral gateway (e.g. NEST security camera) returns or gradually reduce the efforts.

When installing a standalone system without a permanent gateway, a certain peripheral network-service device, e.g. in a form of a smartphone or laptop, is suitably allowed to perform certain well-defined actions (such as reconfiguration, diagnostics, management, SW upgrade) when it connects to the network. In some cases, the identity (configuration, addresses) of the peripheral gateway are known, e.g. when the gateway is a dedicated box or e.g. a gateway robot/drone or a dedicated phone of the facility manager, which only once in a while is brought into the network, e.g. to change network configuration, check the network/device health, collect usage data or provide OTA upgrade. The network-service device may be single purpose i.e. the facility manager connects it and it just can do OTAU and no lighting control or re-commissioning is possible. The same network-service device when used by an authorized installer may allow for re-commissioning and read of granular occupancy data.

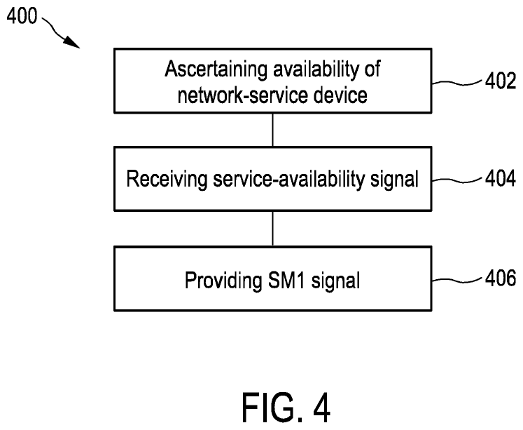

FIG. 4 shows a flow diagram of an embodiment of a method 400 for operating a node-control unit for setting an operation mode of one or more network nodes of a wireless communication network. The method comprises, in a step 402, ascertaining that one or more network-service devices, which are currently external to the wireless communication network are currently available for communication with at least one of the network nodes of the wireless communication network and providing a service-availability signal indicative thereof. The method also comprises, in a step 404, receiving the service-availability signal and, in response thereof, in a step 406 generating and to providing a first switch-mode signal indicative of an instruction to switch the operation mode of the at least one network node from a first operation mode of the at least one network node as a network node of the wireless communication network in a first network configuration, which excludes the network-service device to a second operation mode of the at least one network node as a network node of the wireless communication network in a second network configuration, which includes the at least one network-service device.

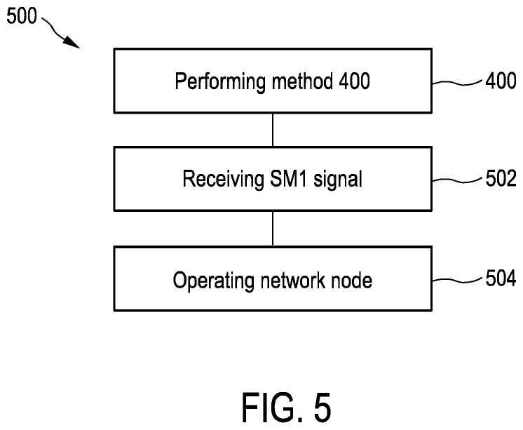

FIG. 5 shows a flow diagram of an embodiment of a method 500 for operating a network node. The method for operating a network node, comprises, performing the method 400 described with reference to FIG. 4. The method also comprises, in a step 502, receiving the first switch-mode signal and in a step 504, operating the network node in the first operation mode or in the second operation mode in dependence of the first switch-mode signal.

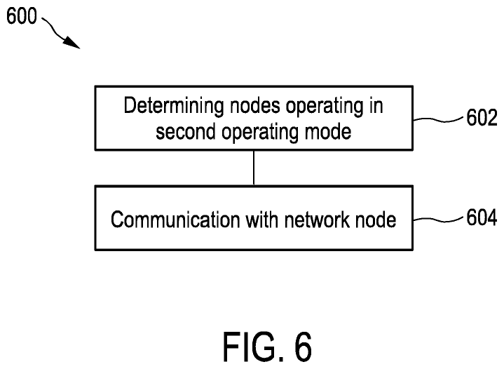

FIG. 6 shows a flow diagram of an embodiment of a method 600 for operating a wireless network-service device for operation in one or more different wireless communication networks. The method comprises, in a step 602, determining that at least one network node of the target wireless communication network is currently in a first operation mode as a network node of the target wireless communication network in a first network configuration, which excludes the network-service device from the target wireless communication network or in a second operation mode as a network node of the target communication network in a second network configuration, which includes the at least one network-service device in the target wireless communication network; and, in a step 604 wirelessly communicating with the at least one network node currently in the second operation mode.

In summary, the invention relates to a node-control unit for setting an operation mode of one or more network nodes of a wireless communication network. It comprises a network-service-detection unit, for ascertaining whether an network-service device is currently available for communicating with the wireless communication network, and to provide a service-availability signal indicative thereof, and an operation-mode setting unit configured to receive the service-availability signal and, to generate and provide based thereon, a first switch-mode signal to at least one network node indicative of an instruction to switch the operation mode from a first operation mode where the network node acts as a node of the wireless communication network to a second operation mode wherein the network node is in communication with the network-service device thereby enabling an ad-hoc adjustment of the functionality of the network node.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A node-control unit for setting an operation mode of one or more network nodes of a wireless communication network, the node-control unit comprising:
a network-service-detection unit which is configured to ascertain a current availability of one or more network-service devices which are currently external to the wireless communication network, for communication with at least one of the network nodes of the wireless communication network and for thus becoming part of the wireless communication network, and to provide a respective service-availability signal (SA) indicative thereof;
an operation-mode setting unit configured to control switching of an operation mode of at least one of the network nodes of the wireless communication network between:
a first operation mode (OM1) of the at least one network node as a network node of the wireless communication network in a first network configuration, which excludes the respective network-service device from the wireless communication network; and
a second operation mode (OM2) of the at least one network node as a network node of the wireless communication network in a second network configuration, which includes respective network-service device in the wireless communication network; wherein the one or more network-service devices is configured to perform in communication with the one or more network nodes, operating in the second operation mode, a commissioning function of at least one network node of the wireless communication network;
wherein
the operation-mode setting unit is further configured, in response to receiving the respective service-availability signal (SA), to generate and to provide, via an output interface, a corresponding first switch-mode signal (SM1) to at least one of the one or more network nodes of the wireless communication network, the first switch-mode (SM1) signal being indicative of an instruction to switch the operation mode of the at least one network node from the first operation mode to the second operation mode with respect to the given network-service device.

2. The node-control unit of claim 1, wherein the operation-mode setting unit is further configured:
to ascertain service-allowance information indicative of one or more network-service devices that are capable of connecting to at least one network node of the wireless communication network and that are allowed to join the wireless communication network;
to determine, using the service-allowance information, whether the one or more network-service devices currently available for communicating with at least one of the network nodes of the wireless communication network are network-service devices allowed to enter the wireless communication network, and to provide an allowance signal indicative thereof; and
to provide the first switch-mode signal also in dependence on the allowance signal.

3. The node-control unit of claim 1, wherein:
the network-service-detection unit is configured to determine whether at least one of the network-service devices is currently connected to the wireless communication network and to provide a respective service-connected signal indicative thereof; and wherein
the operation-mode-setting unit is configured to provide to at least one of the nodes of the wireless communication network, via the output interface, a second switch-mode signal (SM2) indicative of an instruction to switch the operation mode of the at least one network node from the second operation mode (OM2) to the first operation mode (OM1) when the respective service-connected signal is indicative of the network-service device not being currently connected to the communication network.

4. The node-control unit of claim 1, further comprising:
a node-identification data ascertainment unit configured to ascertain node-identification data indicative of at least one of the network nodes that currently form part of the wireless communication network;
a storage-unit configured to store the ascertained node-identification data; and
a network-service-device update unit which is configured to provide, upon receiving a predetermined enabling instruction, the stored node-identification data to the network-service device.

5. The node-control unit of claim 1, further comprising:
a network-operation data ascertainment unit configured to ascertain network-operation data indicative of communication processes between the network nodes and a first network-service device that is connected to the wireless communication network;
a storage-unit configured to store the ascertained network-operation data; and
a network-service-device update unit configured to, upon receiving a predetermined enabling instruction, to provide the stored network-operation data to a second network-service device different from the first network-service device.

6. A network node, comprising;
a node-control unit according to claim 1;
a node-operation unit operable in the first and the second operation mode, the node-operation unit configured to receive the first switch-mode signal from the node-control unit and to operate in the first operation mode or in the at least one second operation mode with respect to a respective available network-service device in dependence thereon;
wherein the node-operation unit is configured to perform, when operating in the second operation mode, a commissioning function of at least one network node of the wireless communication network.

7. The network node of claim 6, wherein the node-operation unit is configured to perform, when operating in the second operation mode, one or more of the following functions:
a node-validation function for validating a proper connection of at least one network node to the wireless communication network in accordance with a predetermined connection criterion;
a configuration-validation function for validating a proper configuration at least one network node of the wireless communication network in accordance with a predetermined configuration criterion;
a software update function for updating a software used by at least one network node of the wireless communication network;
a firmware update function for updating a firmware used by at least one network node of the wireless communication network;
a fine-tune configuration function for adjusting operation parameters of at least one network node of the wireless communication network in the first or second operation mode;
a network node-usage monitoring function, for determining, during a predetermined time span, and providing node usage information quantity indicative of a cumulated time of operation and consumed network bandwidth of at least one network node of the wireless communication network;
a network-operation monitoring function for determining, during a predetermined time span, and providing a network operation quantity indicative of an error rate of communication within the wireless communication network;
a node-operation testing function, for testing a predetermined operation functionality of at least one of the nodes of the wireless communication network
a network cyber-security monitoring function for monitoring traffic patterns within the wireless communication network and detecting target traffic patterns indicative of a presence of a rogue node in accordance with a predetermined rogue-node detection algorithm;
a presence-sensing function for sensing presence of a subject in a presence-sensing volume associated to the wireless communication network, the presence sensing function including determining received signal-quality indicator values of;
a remote-access function for allowing remote access to the network node by an external device;
a network-information provision function for ascertaining and providing network-information pertaining to the network nodes currently forming part of the wireless communication network;
a position determination function, for determining an approximate position of the network-service device;
a network-node addition function, for connecting one or more external nodes to the wireless communication network, and
an asset-tracking function, for tracking location of one or more target devices using beacon signals provided by the target devices in accordance with a predetermined communication protocol.
an indoor positioning service function using beacon signals provided by the network devices.

8.-11. (canceled)

12. A method for operating a node-control unit for setting an operation mode of one or more network nodes of a wireless communication network, the method comprising:
ascertaining that one or more network-service devices, which are currently external to the wireless communication network are currently available for communication with at least one of the network nodes of the wireless communication network and providing a service-availability signal indicative thereof;
in response to receiving the service-availability signal;
generating and providing, a first switch-mode signal indicative of an instruction to switch the operation mode of the at least one network node from a first operation mode of the at least one network node as a network node of the wireless communication network in a first network configuration, which excludes the network-service device to a second operation mode of the at least one network node as a network node of the wireless communication network in a second network configuration, which includes the at least one network-service device; wherein the one or more network-service devices is configured to perform in communication with the one or more network nodes, operating in the second operation mode, a commissioning function of at least one network node of the wireless communication network.

13. A method for operating a network node, comprising;
performing the method of claim 12;
receiving the first switch-mode signal;
operating the network node in the first operation mode or in the second operation mode in dependence of the first switch-mode signal.

14. (canceled)

15. (canceled)
